(19) United States
(12) Patent Application Publication
(10) Pub. No.: US 2024/0001769 A1
(43) Pub. Date: Jan. 4, 2024

(54) AUTOMATIC DETACHING OF A MINING PANTOGRAPH

(71) Applicant: SANDVIK MINING AND CONSTRUCTION OY, Tampere (FI)

(72) Inventors: Ville VARE, Tampere (FI); Jari UUSITALO, Tampere (FI)

(21) Appl. No.: 18/039,022

(22) PCT Filed: Nov. 30, 2020
(86) PCT No.: PCT/EP2020/083858

§ 371 Date: May 26, 2023

(51) Int. Cl. B60L 5/24; E21F 17/06

(52) U.S. Cl. CPC B60L 5/24; E21F 17/06

(57) ABSTRACT

A device and a method for detaching a current collector of a mining vehicle before a track end in response to a sufficient voltage drop is provided. Timely detachment of the current collector is further ensured with one or more sensor arrangements. A trolley track system incorporating the device is also provided.

### TECHNICAL FIELD

The present application relates to the field of mining vehicles. In particular, some example embodiments relate to automatic detaching of a pantograph of a mining vehicle.

### BACKGROUND

Pantograph of a mining vehicle must be detached from a trolley track before a track end to prevent damages on the pantograph or other equipment. For example, when the track ends the spring suspension of the pantograph rises to a maximum position and may get caught to something, such as a ventilation pipe. In order to prevent damages on the infrastructure or the mining vehicle, the pantograph is typically manually detached from the trolley track.

### SUMMARY

It is an objective to provide a device and a method for detaching a current collector of a mining vehicle without any user input before an end of overhead lines.

Further, a trolley track system to enable the automatic detachment is provided. The objective is achieved by the features of the independent claims. Some embodiments are described in the dependent claims.

According to a first aspect, there is provided a device for detaching a current collector of a mining vehicle from overhead lines, the device configured to monitor supply voltage of the overhead lines obtained by the current collector; detect a voltage drop in the supply voltage, wherein the voltage drop exceeds a predefined limit; and trigger detaching of the current collector from the overhead lines in response to the voltage drop. In an embodiment, the predefined limit is bigger than normal fluctuations of the supply voltage.

In an embodiment, in addition or alternatively, the device is further configured to obtain data associated to at least one sensor configured to indicate when the mining vehicle has reached a predetermined location; and trigger detaching of the current collector from the overhead lines in response to the mining vehicle reaching the predetermined location.

In an embodiment, in addition or alternatively, the device comprises at least one pair of a lever switch and an indicator pole, wherein the lever switch is configured to be mounted on the current collector and the indicator pole at the predetermined location such that detaching of the current collector is triggered when a position of the switch lever is changed in response to the current collector passing the indicator pole.

In an embodiment, in addition or alternatively, the device comprises at least one transmitter and a receiver, wherein at least one of the transmitter or the receiver is configured to be positioned at the predetermined location and the transmitter is configured to provide an indication to the receiver in response to the mining vehicle reaching the predetermined location.

In an embodiment, in addition or alternatively, the device comprises at least one sensor configured to measure distances along a route of the mining vehicle; and the device is configured to compare the distances measured by the sensor to predetermined distances obtained from a route the mining vehicle travels along the overhead lines to determine a current location of the mining vehicle on the route; and determine when the mining vehicle has reached the predetermined location based on the comparison.

According to a second aspect, there is provided a current collector comprising the device of the first aspect.

According to a third aspect, there is provided a mining vehicle comprising a current collector and the device of the first aspect.

According to a fourth aspect, there is provided a trolley track system comprising at least two overhead lines, wherein end sections of the overhead lines comprise a more lossy material than the rest of the overhead lines, the lossy material causing a linear voltage drop in a supply voltage of the overhead lines.

In an embodiment, a percentage of the lossy material increases towards the end of the overhead lines such that the voltage drop is higher than in normal fluctuations of the supply voltage.

In an embodiment, in addition or alternatively, the more lossy material comprises a different metal than the rest of the overhead lines.

In an embodiment, in addition or alternatively, the more lossy material comprises a non-conductive material.

In an embodiment, in addition or alternatively, the trolley track system comprises at least one of the device of the first aspect or the mining vehicle of the third aspect.

According to a fifth aspect, there is provided a method for detaching a current collector of a mining vehicle from overhead lines. The method comprises monitoring a supply voltage of overhead lines obtained by the current collector; detecting a voltage drop in the supply voltage, wherein the voltage drop exceeds a predefined limit; and triggering detaching the current collector from the overhead lines in response to the voltage drop.

According to a sixth aspect, there is provided a computer program comprising computer code which, when executed by at least one processing unit, causes the at least one processing unit to perform the method of the fifth aspect.

In an embodiment, the computer program is embodied on a computer readable medium.

### BRIEF DESCRIPTION OF THE DRAWINGS

The accompanying drawings, which are included to provide a further understanding of a subject-matter and constitute a part of this specification, illustrate embodiments of the subject-matter and together with the description help to explain the principles of the subject-matter. In the drawings:

FIG. 1 illustrates a device configured for detaching of a current collector of a mining vehicle according to an embodiment.

FIG. 2 illustrates a mining vehicle comprising a device configured for detaching of a current collector of the mining truck based on a linear voltage drop in overhead lines according to an embodiment.

FIG. 3 illustrates an overhead line comprising a change in material properties according to an embodiment.

FIG. 4 illustrates a trolley track system comprising a plurality of mechanisms for automatic detaching of a current collector of a mining truck according to an embodiment.

FIG. 5 illustrates a device comprising at least one lever switch and an indicator pole configured for detaching of a current collector of a mining truck according to an embodiment.

FIG. 6 illustrates a device comprising two lever switches and two indicator poles arranged in rows and configured for detaching of a current collector of a mining truck according to an embodiment.

FIG. 7 illustrates a method for detaching of a current collector of a mining truck according to an embodiment.

### DETAILED DESCRIPTION

In a mining environment, it may be hard to detect when the overhead lines end in order for a driver of a mining truck to detach a current collector of the mining truck, such as pantograph, from the overhead lines at a right time. Furthermore, as the transportation is getting more and more automated also in the mining industry, automatic detaching of the pantograph is necessary for full automation. By automating the detachment of pantograph before the trolley track end, damages caused by running out of the overhead lines while the pantograph is still in the upward position may be avoided.

According to an example embodiment, a device is provided to automatically detach a current collector of a mining vehicle in response to a detected sufficient voltage drop of an overhead lines. The voltage drop may be caused with a more lossy overhead line section than the rest of the overhead lines. For example, one section of the overhead lines may comprise a different metal or a non-conductive material such that the supply voltage decreases linearly when approaching the end of the overhead lines. In an embodiment, the device may be additionally configured to detect when the overhead lines are about to end, for example, in response to a triggered switch or based on a location of the mining vehicle indicated by a transmitter-receiver pair to ensure detachment of the current collector.

An example embodiment enables, that passing the track end with the current collector engaged to the overhead lines may be prevented. Hence, damages on infrastructure or equipment may be avoided.

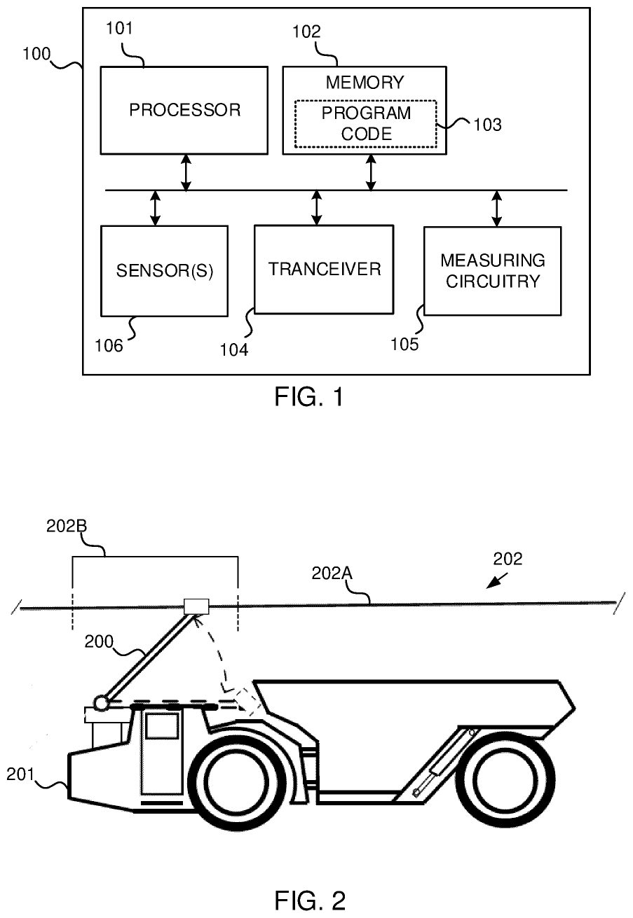

FIG. 1 illustrates a device 100 configured for detaching of a current collector of a mining vehicle according to an embodiment. In an embodiment, the current collector or the mining vehicle may comprise the device 100. Although the device 100 is illustrated as a single device it is appreciated that, wherever applicable, functions of the device 100 may be distributed to a plurality of devices.

The device 100 may comprise at least one processor 101. The device 100 may further comprise at least one memory 102 comprising program code 103 which, when executed by the at least one processor 101, causes the device 100 to practice one or more example embodiments. The device 100 may comprise a transceiver 104 configured to enable the device 100 to transmit and/or receive information to/from other devices. The transceiver 104 may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection.

In an embodiment, the device 100 may comprise a measuring circuitry 105, such as a voltage measurement device. The voltage measurement device may be configured to measure supply voltage obtained by the current collector from the overhead lines. The device 100 may further comprise one or more sensors 106, such as a lever switch, an RFID receiver, an RFID tag, an infrared transmitter, an infrared receiver, a sensor configured to measure distances and/or to laser scan shapes of surroundings and objects. The measured distance may comprise travel distance or distance of objects.

The exemplary embodiments and aspects of the subject-matter can be included within any suitable device, for example, including, servers, workstations, capable of performing the processes of the exemplary embodiments. The exemplary embodiments may also store information relating to various processes described herein.

Example embodiments may be implemented in software, hardware, application logic or a combination of software, hardware and application logic. The example embodiments can store information relating to various methods described herein. This information can be stored in one or more memories 102, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories for holding instructions programmed according to the teachings and for holding data structures, tables, records, and/or other data described herein. In an example embodiment, the application logic, software 10 or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

FIG. 2 illustrates a mining vehicle 201 comprising a device 100 configured for detaching of a current collector of the mining truck based on a linear voltage drop in overhead lines 202 according to an embodiment.

The mining vehicle 201 may be an electric vehicle configured to collect current from a trolley track system comprising at least two overhead lines 202. The overhead lines 202 may comprise, for example, wires and/or trails suspended above a route of the mining vehicle 201. The current collector 200 may be mounted on a roof of the mining vehicle 201. The current collector 200 may be, for example, a pantograph, a bow collector or trolley poles. The current collector 200 may comprise spring-loaded arms to attach to the overhead lines 202 by pressing the current collector 200 and its electrical contact against the overhead lines 202. The current collector may draw power from the overhead lines 202 to feed power to the mining vehicle by sliding along the overhead lines 202 as the mining vehicle moves.

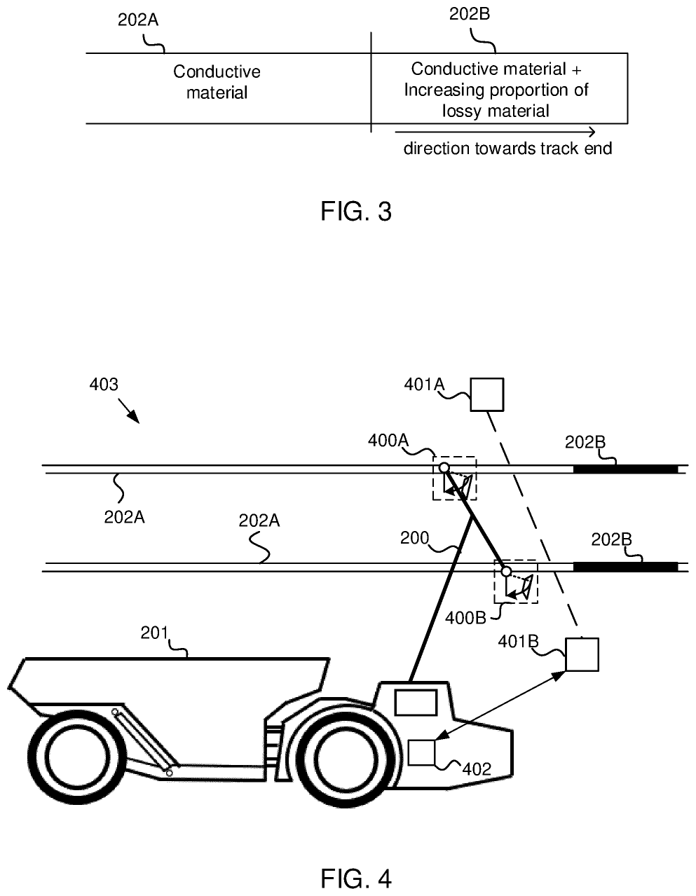

The overhead lines 202 may comprise a change in material properties, as shown in FIG. 3. In an embodiment, an end section of the overhead lines 202B comprises a more lossy material than the other sections of the overhead lines 202A. The more lossy overhead line section 202B may comprise a whole end section of the overhead lines or a necessary portion of the end section such that the current collector is detached timely before the trolley track end. The more lossy overhead line section 202B may be manufactured from a different metal or with a different profile. The more lossy overhead section 202B may comprise, for example, a non-conductive material. The amount of the more lossy material may increase towards the trolley track end. Therefore, resistance of the overhead lines 202 may increase towards the trolley track end. The increased resistance causes a supply voltage of the overhead lines to decrease. The more lossy material may be combined with a conductive material of the overhead lines 202 such that the voltage loss towards the trolley track end is linear. A sudden drop in the supply voltage would cause unnecessary strain for the electric system and the direction of the current may suddenly change. Thus, the linear change enables preventing surge currents and limiting voltage deviations. In an embodiment, the percentage of the more lossy or non-conductive material may increase towards the end of the overhead lines. The amount and length of use of the more lossy material may be selected such that the supply voltage may decrease linearly at least over a predefined limit such that the supply voltage decreases below a configured trigger voltage. The predefined limit may correspond to a fault situation. The predefined limit may be bigger than normal fluctuation of the supply voltage. In general, the supply voltage may not be constant, and it may vary around a nominal voltage value. The normal fluctuations of the voltage may be, for example, ±3-10% of the nominal voltage. Voltage fluctuations above the normal fluctuations may indicate a fault and be harmful for the system. The normal fluctuations allowed for the supply voltage may depend on the supply system. In an embodiment, the predetermined limit may be, for example, at least 5 to 10, 20 to 30, 5 to 30 or 5 to 40 percent of a nominal supply voltage of the trolley track system. The predetermined limit may depend on typical supply voltage of the overhead lines 202 as well as normal voltage deviations in the trolley track system. The linear voltage drop exceeding the predefined limit enables, that the trolley track end may be separated from other voltage deviations. Hence, the current collector may not be unnecessary detached due to normal voltage fluctuation.

The device 100 may monitor the supply voltage of the overhead lines 202. In an embodiment, the device 100 may comprise a voltage measurement device configured to monitor the supply voltage as perceived by the mining vehicle 201. Alternatively, the device 100 may receive the measurement data from the voltage measurement device. When the supply voltage is below a predetermined voltage limit, the device 100 may cause the current collector 200 to disengage from the overhead lines 202. The supply voltage triggering the detachment of the current collector may be configured to be lower than a normal overhead lines voltage minus a margin for normal voltage fluctuation. The device 100 may trigger the detachment of the current collector based on the voltage drop value or based on the detected trigger supply voltage. Once the current collector 200 is disengaged, it may be lowered to a resting position on top of the roof of the mining vehicle 201.

In addition to the voltage drop caused by the modified overhead line sections, also other voltage drops exceeding the predefined limit may cause the device 100 to trigger detachment of the current collector. For example, in case of some kind of failure in the power supply system, such as when a supply station goes off causing a loss of supply voltage, the current collector 200 may be caused to automatically disengage. Triggering the disengagement from voltage supervision may prevent electrical equipment of the mining vehicle 201 from powering the overhead lines 202 in case of a supply failure.

FIG. 4 illustrates a trolley track system 403 comprising a plurality of mechanisms for automatic detaching of a current collector 200 of a mining truck 201, according to an embodiment. The trolley track system 403 may comprise the device 100. The device 100 may be configured to monitor data from more than one sources in order to trigger detaching of the current collector 200. The trolley track system 403 comprises at least two overhead lines 202 with sections made with a more lossy material 202B than the rest of the overhead lines 202A. The device 100 may be comprised in the current collector 200 or the mining vehicle 201 and detect the voltage drop caused by the more lossy overhead line section 202B, as described earlier. In an embodiment, the device 100 may be configured to trigger the detachment in response to data obtained from one or more sensors detecting when the mining vehicle 201 has reached a predetermined location before the ending of the overhead lines 200. The mining vehicle based detachment enables a back-up solution for the voltage supervision based detachment.

In an embodiment, one or more sensors 401A, 401B, such as RFID tags or receivers, may be mounted by the trolley track and configured to trigger detaching the current collector 200. In an embodiment, at least one sensor 402 may be mounted on the mining vehicle 201. The mining vehicle 201 may comprise, for example, a RFID receiver configured to transmit and receive data to/from the RFID tag mounted on a wall or another location nearby the trolley track end where the overhead lines end. When the RFID reader passes near the RFID tag, the data received from the RFID tag may trigger the device 100 to disengage the current collector 200. The data may comprise an indication that the location of the mining vehicle 201 corresponds to a predetermined location near the trolley track end. Alternatively, the RFID tag may be mounted on the mining vehicle 201 and the RFID receiver may be mounted near the trolley track end.

In an embodiment, the device 100 may obtain a route model of the mining vehicle 201 on the trolley track and compare it to a detected trip profile of the mining vehicle 201 to determine when the current collector 200 needs to be detached. The trip profile may be detected, for example, by measuring distances based on illuminating surrounding objects with laser light and measuring the reflection with a sensor 402 mounted on the mining vehicle 201. The sensor may be a lidar configured for laser scanning shapes of a mine comprising the trolley track system. The route model may comprise stored information about the tunnel shape in each location along the trolley track which may be compared to the trip profile to determine the current location of the mining truck 201. Alternatively, or in addition, the trip profile may be detected with any other trip data recorder. The trip data may be recorded, for example, with a plurality of RFID readers mounted along the trolley track and an RFID tag mounted on the mining vehicle 201 such that location of the mining vehicle 201 is received each time RFID reader is passed. Alternatively, or in addition, the mining vehicle 201 may comprise a device configured to measure a distance travelled by the mining vehicle 201. The length of the trolley track may be known and compared to the measured distance to determine the location of the mining vehicle 201. When the predetermined location is reached, the device 100 may trigger detaching of the current collector 200.

In an embodiment, the sensors 401A, 401B may be configured to establish a light gate or a light curtain at the predetermined location. For example, a first sensor 401A may be an infrared transmitter and a second sensor 401B may be an infrared receiver, the first and the second sensor 401A, 401B being mounted on opposite sides of the overhead lines 202. Once the light gate or curtain triggers, the device 100 may obtain information about the location of the mining vehicle 201 being near the track end and trigger detachment of the current collector 200.

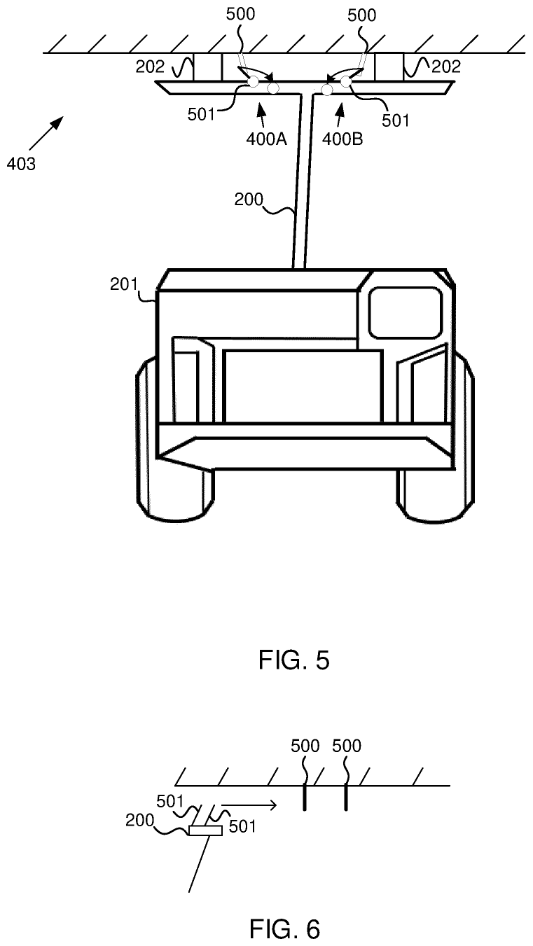

In an embodiment, the device 100 may comprise one or more sensor arrangements 400A, 400B comprising a lever switch configured to trigger in response to passing an indicator mounted nearby the overhead lines 202 at a predetermined location. The indicator may be a pole configured to change a position of the switch lever as the current collector 200 passes the pole. FIG. 5 illustrates an example of a front view of the sensor arrangements 400A, 400B comprising two lever switches 501 mounted on the current collector 200 and the indicator poles 500 mounted on a ceiling by the overhead lines 202, wherein the indicator poles 500 operate the lever switches 501 in response to the mining vehicle 201 travelling past the indicator poles 500. FIG. 5 illustrates one possible arrangement of the indicator poles and the lever switches. The indicator poles and the lever switches may be also arranged differently, for example in line one after another. FIG. 6 illustrates an example embodiment, wherein the two indicator poles 500 are mounted in a row, for example, on the ceiling by the overhead lines and the two lever switches 501 are placed in a row on the current collector 200. FIG. 6 is depicted from a side with respect to a direction of travel of a mining vehicle comprising the current collector 200. The two lever switches 501 and the two indicator poles 500 may be placed so that both of the lever switches 501 are configured to hit both of the indicator poles 500. Hence, a type of failure may be indicated when one of the switches fails to trigger. For example, it may be determined if one of the lever switches is broken or if one of the indicator poles are broken. In addition to the provided additional information about an origin of the problem, a single trigger signal may be enough to trigger pantograph detaching. Doubling the switches and the respective indicators may provide a fail-safe system as a failure in one switch or one indicator may be allowed without losing triggering of the detachment command as long as state of one of the switches is changed by the indicator. Further, indication of a failure of one switch or indicator may be received in the event of only one triggered switch for maintenance.

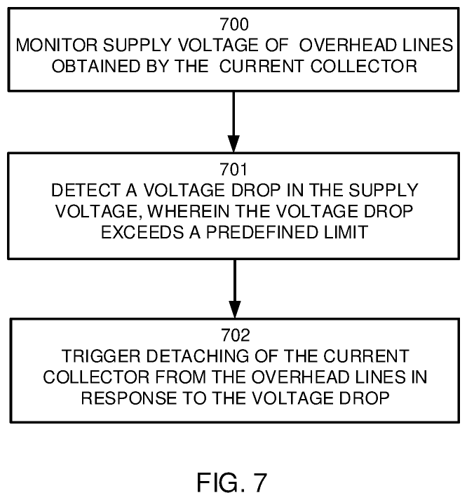

FIG. 7 illustrates a method for automatic detaching of a current collector of a mining truck according to an embodiment. The method may be performed, for example, by the device 100.

At 700, the method comprises monitoring supply voltage of the overhead lines obtained by the current collector. In an embodiment, the supply voltage may be monitored by a voltage measuring circuitry comprised in the device 100.

At 701, the method comprises detecting a voltage drop in the supply voltage, wherein the voltage drop exceeds a predefined limit. In an embodiment, the method may comprise detecting a linear voltage drop to distinguish end of track from fault situations of the trolley track system. The predefined limit may be sufficient to prevent unnecessary detachment of the current collector, for example, due to normal supply voltage deviations.

At 702, the method comprises triggering detaching of the current collector from the trolley track in response to the voltage drop. The trigger may comprise sending a command to detach the current collector or controlling the detachment directly, such as by operating a switch configured to withdraw the current collector from an upward position attaching the current collector to the overhead lines.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method operations which perform substantially the same function in substantially the same way to achieve the same results are within the scope of the disclosure. Moreover, it should be recognized that structures and/or elements and/or method operations shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A device (499) for detaching a current collector of a mining vehicle from overhead lines, the device being configured to:
monitor supply voltage of the overhead lines obtained by the current collector;
detect a voltage drop in the supply voltage, wherein the voltage drop exceeds a predefined limit; and
trigger detaching of the current collector from the overhead lines in response to the voltage drop.

2. The device (490) of claim 1, wherein the predefined limit is bigger than normal fluctuations of the supply voltage.

3. The device (490) of claim 1, wherein the device is further configured to:
obtain data associated to at least one sensor configured to detect when the mining vehicle has reached a predetermined location at the overhead lines; and
trigger detaching of the current collector from the overhead lines in response to the mining vehicle reaching the predetermined location.

4. The device (404) of claim 3, comprising at least one pair of a lever switch and an indicator pole, wherein the lever switch is configured to be mounted on the current collector and the indicator pole at the predetermined location such that detaching of the current collector is triggered when a position of the switch lever is changed in response to the current collector passing the indicator pole.

5. The device (490) of claim 3, further comprising at least one transmitter and a receiver, wherein at least one of the transmitter or the receiver is configured to be positioned at the predetermined location and the transmitter is configured to provide an indication to the receiver in response to the mining vehicle reaching the predetermined location.

6. The device of claim 3, further comprising at least one sensor configured to measure distances; and the device being configured to:
compare the distances measured by the sensor to predetermined distances obtained from a route the mining vehicle travels along the overhead lines to determine a current location of the mining vehicle on the route; and
determine when the mining vehicle has reached the predetermined location based on the comparison.

7. A current collector comprising the device of claim 1.

8. A mining vehicle comprising:
a current collector; and
the device of claim 1.

9. A trolley track system comprising:
at least two overhead lines, wherein end sections of the overhead lines include a more lossy material than a rest of the material of the overhead lines, the more lossy material causing a linear voltage drop in a supply voltage of the overhead lines.

10. The trolley track system of claim 9, wherein a percentage of the more lossy material increases towards the end of the overhead lines such that the voltage drop is higher than in normal fluctuations of the supply voltage.

11. The trolley track system of claim 9, wherein the more lossy material includes at least one of a different metal than the rest of the material of the overhead lines or a non-conductive material.

12. The trolley track system of claim 9, further comprising at least the device of for detaching a current collector of a mining vehicle from overhead lines, the device being configured to:
monitor supply voltage of the overhead lines obtained by the current collector;
detect a voltage drop in the supply voltage, wherein the voltage drop exceeds a predefined limit; and
trigger detaching of the current collector from the overhead lines in response to the voltage drop, wherein the mining vehicle includes the device and a current collector.

13. A method for detaching a current collector of a mining vehicle from overhead lines, the method comprising:
monitoring a supply voltage of the overhead lines obtained by the current collector; detecting a voltage drop in the supply voltage, wherein the voltage drop exceeds a predefined limit; and
triggering detaching of the current collector from the overhead lines in response to the voltage drop.

14. A computer program comprising computer code, which when executed by at least one processing unit, causes the at least one processing unit to perform the method of claim 13.

15. The computer program of claim 14, wherein the computer program is embodied on a computer readable medium.
